(19) United States
(12) Patent Application Publication
(10) Pub. No.: US 2005/0259427 A1
(43) Pub. Date: Nov. 24, 2005

(54) Relaxation lamp

(76) Inventor: Roy D. Clark, Columbia, LA (US)

Correspondence Address: LITMAN LAW OFFICES, LTD, PO BOX 15035, CRYSTAL CITY STATION, ARLINGTON, VA, 22215, US

(21) Appl. No.: 10/849,885

(22) Filed: May 21, 2004

(51) Int. Cl. F21S 8/00; F21V 11/00

(52) U.S. Cl. 362/351

(57) ABSTRACT

The relaxation lamp has an elongated tubular body extending vertically from a base to a removable top closure opposite the base. The elongated tubular body is made from a plurality of vertically extending slats and a plurality of vertically extending moldings connecting the slats in the elongated tubular body to form a plurality of adjacent side walls. A plurality of pegs disposed interiorly of the upper end of the side walls, the pegs connected to the moldings for support of the removable top closure. A light fixture disposed interiorly of the lower end of the side walls, the light fixture fasten to a member that is connected to the base and a protective coating applied to lamp to form a seal. The light fixture illuminates the lamp to create an atmosphere of serenity.

### BACKGROUND OF THE INVENTION

1. Field of the Invention

The present invention relates generally to light fixtures. More particularly the relaxation lamp is a light fixture that radiates a soothing light in a darkened room, creating a relaxing environment.

2. Description of the Related Art

There are a wide variety of lamps to meet the various demands of illumination and decorative design. Most of these lamps address the concern of illuminating a room for visibility, but this type of light is not conducive to relaxation. Hence, some people use candles as an alternative to lamps in order to create an atmosphere of serenity. However, candles can present the possibility of house fires and the smoke from the candles may be hazardous because of the metallic materials used in the candlewick.

Therefore, there exists a continuing need for an environmentally friendly lamp that creates an illumination of serene iridescence conducive to relaxation.

U.S. Pat. No. 3,780,287, issued Dec. 18, 1973 to Fauri, describes a lamp shade having a generally tubular member of flexible sheet metal, a U-shaped ring of flexible resilient material with an internal flange of generally C-shape in section, and a rigid metal ring embraced and held by each flange, whereby the lamp shade can be folded to flat form.

U.S. Pat. No. 4,035,633, issued Jul. 12, 1977 to Grumbeck, discloses a lamp shade adapted to be mounted on a frustoconical frame. The lamp shade has a tubular body made of vertically extending slats connected together by means of horizontally extending and vertically spaced strands of yarn. The shade may be used as a slipcover over an existing lamp shade and frame to enhance the decorative harmony in any room equipped with curtains or drapes of that type.

U.S. Pat. No. 4,050,490, issued Sep. 27, 1977 to Werner, teaches a method for fabricating a lamp, wherein the lamp base is made by providing a polyhedral block of wood and cutting the vertical plane faces of the block to form vertically curved sides while still maintaining the straight shape of the faces in the horizontal direction.

U.S. patent Publication No. 2003/0048637, published Mar. 13, 2003, discloses a black light display device comprising a fixture, a spindle that can be rotated, and a plurality of fluorescent elements that are energized by the black light to display a visible glow.

U.S. patent Publication No. 2003/01232571, published Jul. 2, 2003, shows a light fixture, a hollow and partially light-transparent shade surrounding the lamp, a throughgoing hole having an inner edge, and a transparent prismatic jewel filling the hole such that light emitted by the lamp passes through the jewel.

None of the above inventions and patents, taken either singly or in combination, is seen to describe the instant invention as claimed. Thus, a relaxation lamp solving the aforementioned problems is desired.

### SUMMARY OF THE INVENTION

The relaxation lamp is of a light fixture and a lamp shade surrounding the fixture. The lamp shade has an elongated tubular body extending vertically from a base to a removable top closure. The body is generally cylindrical and made of a plurality of vertically extending slats. The slats are generally arranged in a polygonal shape, specifically a dodecagon, and are connected to a plurality of vertically extending V-moldings to form the sidewalls of the shade body. The sidewalls are generally made of thin wooden slats, specifically ¼″ thick pitch pinewood. A plurality of pegs disposed interiorly of the upper end of the sidewalls are mounted to the moldings to provide support for the removable top closure. A centrally disposed knob-like handle is attached to the removable top closure to allow access to the interior of the lamp.

A light fixture disposed interiorly of the lower end of the sidewalls is mounted to the base to provide illumination. A protective coating of an oil-based polyurethane is applied to the lamp and cured. Once the lamp is cured, beautiful beams of red light emerge from the lamp, casting a glow of serene iridescence conducive to relaxation.

It is an object of the invention to provide a relaxation lamp that is a cost-efficient means of creating an atmosphere of serenity.

It is a further object of the invention to provide a relaxation lamp that is portable and can be easily connected to an electrical outlet in a room.

Still another object of the invention is to provide relaxation lamp that is environmentally safe.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a relaxation lamp according to the present invention.

FIG. 2A is a top view of the relaxation lamp according to the present invention.

FIG. 2B is a top view of the relaxation lamp according to the present invention with a portion of the cover and the bottom wall broken away.

FIG. 3A is a fragmented side view of the interior of the relaxation lamp of the present invention.

FIG. 3B is a fragmented top view of the sidewall of the relaxation lamp according to the present invention.

FIG. 4A is top view of a relaxation lamp according to the present invention, the cover being removed to show the light fixture.

FIG. 4B is an elevation view of the light fixture of the relaxation lamp mounted to a mounting block.

Similar reference characters denote corresponding features consistently throughout the attached drawings.

### DETAILED DESCRIPTION OF THE PREFERRED EMBODIMENTS

The present invention is a relaxation lamp, designated generally as 10 in the drawings. The lamp 10 has an elongated tubular body with a top end 14 and a bottom end 12. The body extends vertically from a base or bottom wall 40, and the top end 14 is open and fitted with a removable top closure 30 opposite the base 40. A centrally disposed knob-like handle 34 is connected to the removable top closure or cover 30, which enables the user to gain access to the interior of the elongated tubular body.

Preferably, the handle 34 is turned from spatted wood and is glued to the removable top closure 30. The base 40 and removable top closure 30 are made from ½ inch thick cabinet grade plywood.

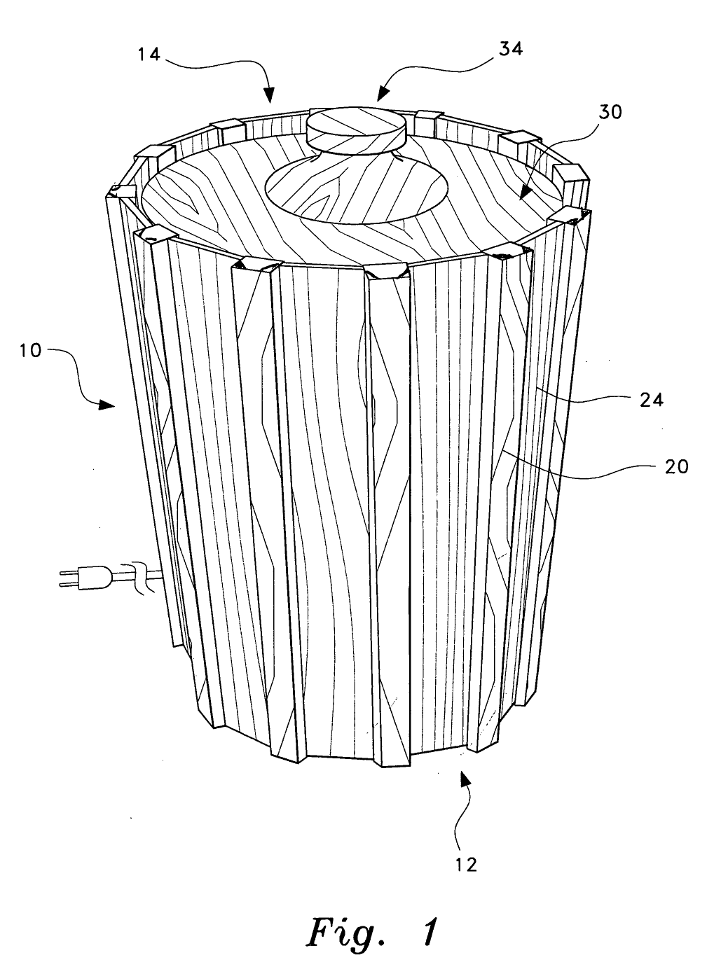

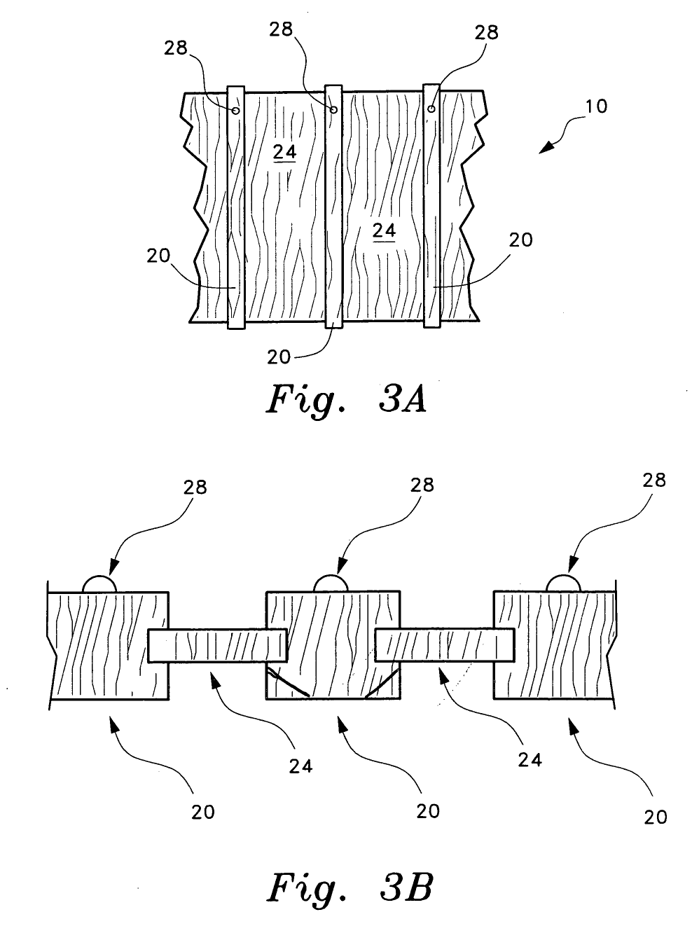

As shown in FIGS. 1, 3A, and 3B, the elongated tubular body 12 is made from a plurality of vertically extending slats 24 and a plurality of vertically extending moldings 20 connecting the slats 24 in the elongated tubular body 12 to form a plurality of adjacent sidewalls joined in a generally polygonal shape, specifically a dodecagon.

Preferably, the lamp 10 is made from wood. The slats 24 are made from pitch pinewood, each slat 24 being approximately ¼ inch thick by 2¾ inches wide by 18 inches tall. The moldings 20 are V-grooved, each molding measuring approximately 1¼ inch by 13/16 inch by 18 inches tall. The slats 24 are arranged in a dodecagonal structure and glued to the V-grooved moldings 20, although other forms of materials with similar structure and capable of performing the same function are within the scope of the present invention.

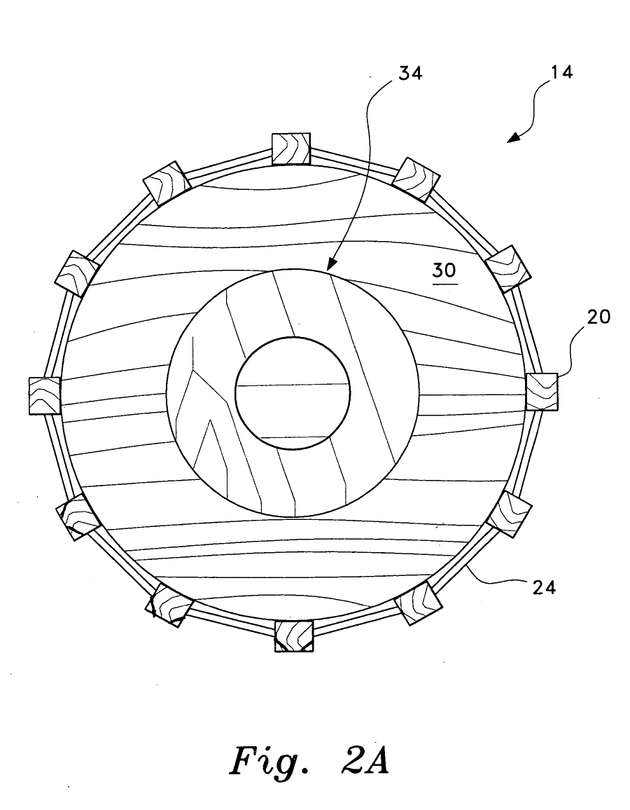

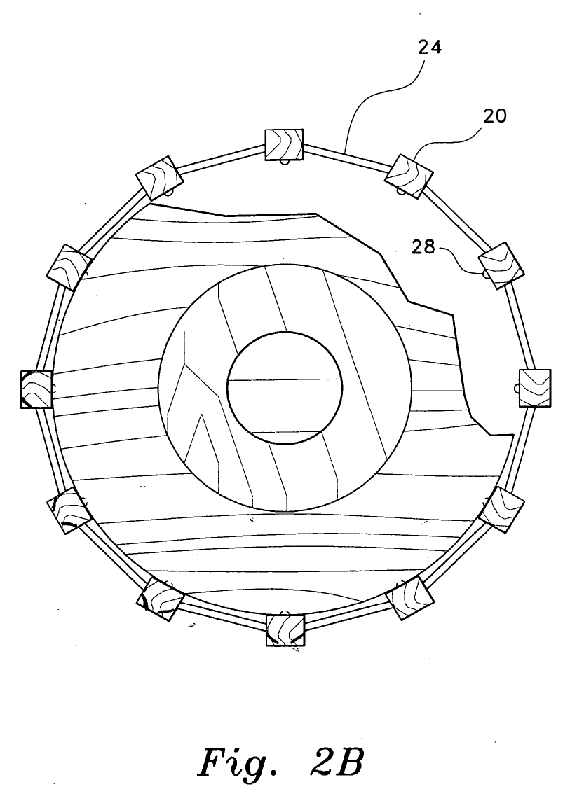

Referring to FIGS. 2A and 2B, a plurality of pegs 28 extend interiorly of the upper end of the sidewalls. The pegs 28 are connected to the moldings 20 to provide support for the removable top closure 30. Moldings 20 are glued to the bottom wall 40 at the bottom end 12 of the lamp 10.

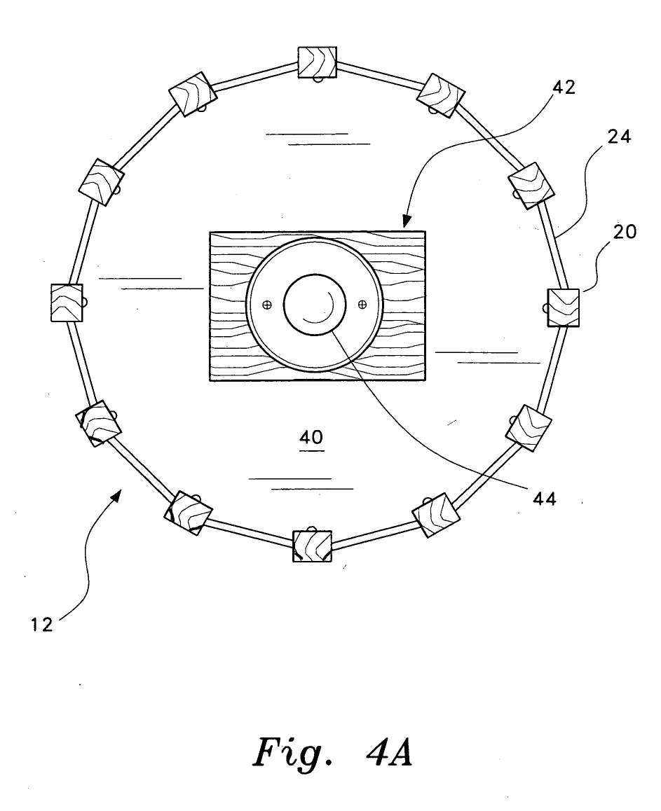

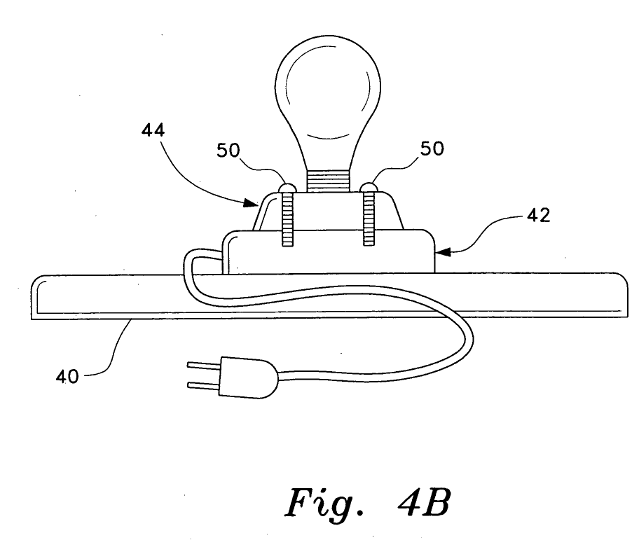

As shown in FIGS. 4A and 4B, a light fixture 44 is centrally disposed interiorly of the lower end of the sidewalls and is fastened by screws 50 to a member 42, such as a 3½ inch by 5½ inch by 5½ inch block of wood. The member 42 is connected to the base 40 with an adhesive, such as glue.

A coating is applied to the lamp 14. Preferably an oil based polyurethane coating is applied to the lamp 14 and cured with a seventy-five watt light bulb in the light fixture 44 for sixty hours. Once the pitch has cured, the relaxation lamp 10 radiates a soothing light in a darkened room. The thin slats 20, the pitch from the pinewood, and the polyurethane coating combine to produce vertical strips of low intensity light having a color ranging from red to purple, spaced apart by the moldings 24, and also emanating through gaps between the sidewalls and the cover 30 and bottom wall 40, providing a soothing atmosphere.

It is to be understood that the present invention is not limited to the embodiments described above, but encompasses any and all embodiments within the scope of the following claims.

1. A relaxation lamp, comprising:
a plurality of thin slats made from wood and coated with an oil-based polyurethane coating;
a plurality of elongated moldings having longitudinally extending grooves defined therein, the moldings having a thickness greater than the slats, the slats being glued lengthwise between adjacent moldings to define an elongated tubular body having a top end and a bottom end and a substantially polygonal cross section;
a bottom wall attached to the molding at the bottom end of the tubular body;
a plurality of pegs extending inwardly into the tubular body adjacent the top end, the pegs being attached to the moldings;
a light fixture disposed on the bottom wall of the tubular body; and
a cover removably disposed at the top end of the tubular body, the cover resting on the pegs;
whereby the light fixture radiates a low intensity light having a soothing color in a darkened room to provide an atmosphere of serenity.

2. The relaxation lamp according to claim 1, wherein the slats are made from pitch pinewood.

3. The relaxation lamp according to claim 1, wherein the grooves in said moldings form a V-shape.

4. The relaxation lamp according to claim 4, wherein the elongated tubular body is formed from twelve slats and twelve moldings, the body having a substantially dodecagonal shape in section.

5. The relaxation lamp according to claim 1, further comprising a handle attached to said cover.
